(19) United States
(12) Patent Application Publication
(10) Pub. No.: US 2021/0220780 A1
(43) Pub. Date: Jul. 22, 2021

(54) DURABLE MEMBRANES FOR SEPARATION OF SOLUTES FROM ORGANIC SOLVENTS

(71) Applicant: Compact Membrane Systems Inc., Newport, DE (US)

(72) Inventors: ROBERT D. LOUSENBERG, WILMINGTON, DE (US); EVAN A. SOHODSKI, HOCKESSIN, DE (US); KENNETH J. PENNISI, BEAR, DE (US)

(21) Appl. No.: 15/734,029

(22) PCT Filed: Jan. 14, 2019
(86) PCT No.: PCT/US2019/013553

§ 371 Date: Dec. 1, 2020

Related U.S. Application Data
(60) Provisional application No. 62/681,403, filed on Jun. 6, 2018.

(51) Int. Cl. B01D 71/32; B01D 67/00; B01D 69/10; B01D 69/02; B01D 69/12

(52) U.S. Cl. CPC B01D 71/32; B01D 67/0083; B01D 69/10; B01D 69/02; B01D 2323/30; B01D 2325/04; B01D 2325/30; B01D 2323/36; B01D 69/12

(57) ABSTRACT

This invention discloses a thin-film composite thin-film composite membrane that is useful for the separation of solute species in organic solvents and particularly in aggressive, high boiling-point, polar-aprotic solvents such as dimethylsulfoxide, (DMSO), N-Methyl-2-pyrrolidone (NMP), dimethylacetamide (DMAc), dimethylformamide (DMF). Thin-film composite separation performance and durability is greatly enhanced through electrostatic crosslinking of an ionomer selective layer by incorporation of a multi-valent counter-ion. The thin-film composite is resistant to contact with amines and the separation efficiency is tunable by choice of multi-valent counter-ion or through the applied pressure differential across the membrane.

### CROSS-REFERENCE TO RELATED APPLICATIONS

This application claims priority to U.S. Provisional Patent Application No. 62/681,403, filed on Jun. 6, 2018, the disclosure of which is incorporated by reference herein in its entirety.

### GOVERNMENT RIGHTS

This invention was made with government support under 2R44GM103402-03 awarded by the National Institutes of Health. The government has certain rights in the invention.

### FIELD OF THE INVENTION

A thin-film composite membrane comprising a separation layer that comprises an electrostatically-crosslinked ionomer is described. The thin-film composite membrane separation efficiency is pressure-tunable and is particularly useful for the separation of solute species from polar-aprotic solvents and also resistant to contact with amine bases.

### BACKGROUND OF THE INVENTION

Highly polar, aprotic, and aggressive solvents such as dimethylsulfoxide, (DMSO), N-Methyl-2-pyrrolidone (NMP), dimethylacetamide (DMAc), and dimethylformamide (DMF) are widely used in pharmaceutical drug development, fine chemical synthesis, and other manufacturing processes. Boiling points of these solvents are high (i.e. 153° C.) and the isolation of temperature sensitive intermediates and products and their separation from impurities can be challenging using traditional techniques such as distillation, chromatography, or solvent extraction. Filtration using membranes may be less capital intensive and can be carried out at much lower temperatures and energy input. However, improved membrane performance and overcoming long term stability issues with these solvents has been an ongoing challenge.

Organic-solvent nanofiltration is a filtration process for the separation of organic solvents through a semipermeable membrane from relatively low molecular weight solutes. Organic-solvent nanofiltration is distinguished by its operational pressure of approximately 500 kPa (72.5 psi) to 4000 kPa (580 psi) from other filtration processes, such as ultrafiltration (UF) at up to 500 kPa, and reverse osmosis (RO) at >40000 kPa (5800 psi), where only solvent permeates the membrane. Membranes are usually characterized by their nominal molecular weight cutoff (MWCO), wherein 90% of the solute, with a specific molecular weight, is rejected by the membrane. The molecular weight cutoff is experimentally determined and is dependent on the solute properties (e.g. dimensions) in a given solvent under the operating conditions (i.e. temperature and pressure) of the process. Most membranes that are considered for organic-solvent nanofiltration applications have a solute molecular weight cutoff that is between 150 and 1000 grams per mole while the solvent typically has a molecular weight that is less than 150 grams per mole.

Thin-film composite membranes have been used in membrane separation processes such as organic-solvent nanofiltration. The thin-film composite usually comprise layers of dissimilar materials contacted to form a single composite construction. The thin-film composite may comprise a thin separation layer (SL), for solute rejection and high solvent permeance, and a porous-layer support (PLS) for mechanical strength and durability. The porous-layer support should also have high permeance but is usually non-selective. The various thin-film composite layers may be independently optimized to maximize the overall membrane performance. For a review of thin-film composite membranes for organic-solvent nanofiltration see: Marchetti, P., et. al., Molecular Separation with Organic Solvent Nanofiltration: A Critical Review, Chem. Rev. 2014, 114, 10735-10806 (open access). The review highlighted research on thin-film composite membranes having polymeric SL's.

Many polymers that were investigated for use as the separation layer in organic-solvent nanofiltration applications with the previously mentioned polar aprotic solvents were either not compatible, swelled excessively, or were soluble. However, some polyimide and polybenzimidazole separation layer polymers were stabilized through crosslinking reactions. At room temperature, the permeance (or flux) and rejection of R&D-disclosed cross-linked polyimide membranes were stable to at least 120 hours. Some of these membranes such as DuraMem® (Evonik MET Ltd., United Kingdom) are commercially available. The commercial membranes were not recommended for use with chlorinated solvents, amines, or at temperatures above 50° C.

Ionomers, which are copolymers containing pendant ionic groups, have also been described for use in filtration processes. For example, Nafion® (Chemours, Wilmington Del.) is a perfluorinated ionomer containing pendent sulfonic acid groups and is well known for its high chemical and thermal stability. Commercially available and monolithic Nafion® membranes that were relatively thick (25-μm) were used in a process described in U.S. Pat. No. 4,876,403 for the separation and enrichment of alcohol from a feed mixture comprising alcohol, water, and sulfuric acid. A thin-film composite membrane comprising a Nafion® separation layer, with a thickness between 10-nm and 50-μm, and which may incorporate multi-valent cations, was also disclosed but not enabled. The specification was silent towards its use for organic-solvent nanofiltration with polar aprotic solvents. WO 2017/004496 A1 disclosed a thin-film composite membrane and methods for selectively pervaporating a first liquid from a feed mixture comprising the first liquid and a second liquid. The thin-film composite membrane comprised a highly fluorinated or perfluorinated ionomer that may comprise a multi-valent cation. This latter membrane was also suggested for use in organic-solvent nanofiltration applications. However, both publications were silent as to a motivation for changing the cation and did not disclose or demonstrate advantages of multi-valent cations over mono-valent cations. A thin-film composite comprising an ionomer separation layer that incorporates a mono-valent counter ion would not necessarily be successful for organic-solvent nanofiltration applications due to excess swelling or dissolution of the separation layer without a process for ionomer stabilization.

### SUMMARY OF THE INVENTION

This invention discloses a thin-film composite membrane that has pressure-tunable separation-efficiency and processes for the separation of at least one organic solvent from a solution comprising at least one solute; the membrane comprising an ionomer separation layer that is contacted to a porous-layer support, a multivalent counter ion to electrostatically crosslink at least some of the covalently-bound ionic groups within the ionomer separation layer, and comprising the following steps of:
a. exposing the membrane feed side to the solution comprising at least one organic solvent and at least one solute;
b. providing a pressure driving force and producing a solution composition on the membrane permeate side having a lower solute concentration than the feed-side composition.

The thin-film composite membrane preferably comprises a fluorinated-ionomer separation layer, having a thickness that is less than 5-μm, contacted to a preferably much thicker (order of magnitude or greater) fluorinated porous-layer support, such as for example expanded polytetrafluoroethylene. The porous support provides mechanical durability and the fluorinated nature of the membrane components enhances chemical durability. The membrane is therefore particularly useful for organic-solvent nanofiltration separation of aggressive, high boiling-point, and polar-aprotic solvents such as dimethylsulfoxide, (DMSO), N-Methyl-2-pyrrolidone (NMP), dimethylacetamide (DMAc), and dimethylformamide (DMF) from dissolved solutes. The membrane is also resistant to contact with amine bases, and its stability towards swelling or dissolution is also greatly enhanced through electrostatic crosslinking of the ionomer selective-layer by incorporation of a multi-valent counter-ion, such as for example calcium or aluminum. Surprisingly, it was discovered that membrane separation efficiency (i.e. solute rejection) is reversibly pressure-dependent such that the molecular weight cutoff may be adjusted and the separation efficiency may therefore be optimized or tuned using pressure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention. Herein certain terms are used and they are further defined in the following detailed description of the invention.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention

FIG. 1 shows a graph of dry rejection and DMF flux versus time.

FIG. 2 shows a graph of dry rejection and DMF flux versus pressure.

FIG. 3 shows a graph of dry rejection and DMF flux versus time.

FIG. 4 shows a graph of dry rejection and DMF flux versus pressure.

FIG. 5 shows a graph of dry rejection and DMF flux versus pressure.

FIG. 6 shows a graph of dry rejection and DMF flux versus time.

FIG. 7 shows a graph of dry rejection and DMF flux versus pressure.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE INVENTION

The thin-film composite (TFC) membrane of the invention is particularly useful for organic-solvent nanofiltration separation of aggressive, high boiling-point, and polar-aprotic solvents such as dimethylsulfoxide, (DMSO), N-Methyl-2-pyrrolidone (NMP), dimethylacetamide (DMAc), and dimethylformamide (DMF) from dissolved solutes. Thin-film composite separation performance, durability, and stability towards swelling or dissolution is greatly enhanced through electrostatic crosslinking of the ionomer selective-layer by incorporation of a multi-valent counter-ion, such as for example calcium or aluminum. The thin-film composite is also resistant to contact with amine bases, which can be present in these solvents, and the separation performance can also be varied through selection of the multi-valent counter-ion.

Surprisingly, it was discovered that the thin-film composite membrane separation efficiency (i.e. solute rejection) is reversibly pressure-dependent such that the molecular weight cutoff may be adjusted for a particular separation. The separation efficiency increased as the driving force or pressure differential across the thin-film composite increased. For example, the rejection of a dye solute increased from approximately 75% at 100-psig to approximately 95% at 600-psig. While wanting to not be bound by theory, this behavior is believed to be a result of membrane compaction, which is a known pressure induced phenomenon in membrane systems. However, unlike most membrane systems, the membrane compaction herein was readily reversible when the pressure was decreased due to the electrostatic nature (like-charge repulsion) of the multivalent cation crosslinking. The membrane separation efficiency may therefore be optimized or tuned using pressure for a given separation without damage to the membrane from excessive pressure.

As discussed, the thin-film composite membrane is useful for the separation of solutes from solutions comprising organic solvents. By definition, a solution is a homogeneous liquid mixture comprised of two or more substances. In such a mixture, a solute is a substance dissolved in a liquid, known as a solvent. The solute is usually a smaller fraction of the mixture and the solution assumes the liquid phase of the solvent. The process to form a solution is called dissolution and happens at a molecular scale where the effects of chemical polarity are involved, resulting in specific interactions between solute and solvent that are referred to as solvation.

A fluorinated polymer or fluoropolymer is a material containing carbon-fluorine groups. By a carbon-fluorine group is meant a group wherein a fluorine atom is directly bonded to carbon while a carbon-hydrogen group is a group wherein a hydrogen atom is bound directly to a carbon atom. Thus —CF₂— groups contains two carbon fluorine groups, while a —CH₃ group contains three carbon-hydrogen groups. Thus in a homopolymer of, for example, vinylidene fluoride, in which the repeat groups are —CH₂CF₂—, the carbon-hydrogen groups and the carbon-fluorine groups are each 50% of the total of carbon-hydrogen plus carbon-fluorine groups present. The relative amount of carbon-fluorine and carbon-hydrogen groups present can be determined by for example NMR spectroscopy, using ¹³C NMR, or a combination of ¹⁹F and ¹H NMR spectroscopy. In the fluoropolymers of the invention herein, of the total of the carbon-hydrogen groups and the carbon fluorine groups preferably at least 10% are carbon-fluorine groups, preferably 50% or more, and very preferably 75% or more. Especially preferred are perfluoropolymers or fluoropolymers in which there are no carbon-hydrogen groups in the polymer-backbone repeating units. Such fluoropolymers may have very small amounts of “adventitious” carbon-hydrogen groups in the backbone from impure monomers, or groups such as initiator fragments bonded to chains.

Polyelectrolytes are polymers in which repeating units comprise an electrolyte group, which are synonymous with ionic groups. Similarly, an ionomer is a copolymer that comprises both electrically neutral repeating units and repeat units having ionic groups. Ionic groups include for example sulfonic acid, sulfonate, sulfonimide, carboxylic acid, carboxylate, phosphate, phosphonium, and ammonium. The polyelectrolyte or ionomer equivalent weight (EW) is the weight of polyelectrolyte or ionomer containing one mole of ionic groups. A preferred equivalent weight is less than 5000 grams per mole, more preferably less than 2000, and very preferably between 500 and 1000-g/mole. Ionomers containing pendant sulfonate groups are preferred and useful for fabrication of the selective layer of the thin-film composite membrane. The ionomers are preferably fluoropolymers, and more preferably contain 50% or more carbon-fluorine groups. Very preferred ionomers are fluoropolymers in which there are no carbon-hydrogen groups in the polymer-backbone repeating units. Examples of the latter ionomers are well known in the art and include copolymers comprising tetrafluoroethylene repeat units and repeat units of a perfluorovinylether, having a pendant sulfonate group, such as for example Aquivion® (Solvay, Houston, Tex.) or Nafion® (Chemours, VVilmington, Del.).

The separation layer of the thin-film composite membrane is fabricated by casting a dilute ionomer solution at concentrations that are between 0.1% and 5%, more preferably between 0.5% and 2%, and very preferably between 0.5 and 1%. The ionomer solution may comprise more than one type of ionomer, or associated counter ions. For example, an ionomer comprising covalently bound ionic groups such as carboxylate or sulfonate may have monovalent counter ions that comprise for example H⁺, Li⁺, Na⁺, K⁺, ammonium, or alkyl ammonium. Herein, an acid-form ionomer (AFI) solution, having a H⁺ counter ion, is preferred for fabrication of a separation layer precursor. Especially preferred acid-form ionomer solutions comprise low equivalent weight ionomers that are copolymers comprising 1,1,2,2-tetrafluoro-2-[(trifluoroethenyl)oxy]ethanesulfonic acid and tetrafluoroethylene, such as for example Aquivion® (Solvay, Houston, Tex.).

Many acid-form ionomer solutions such as Nafion® or Aquivion® are commercially available at 5 to 28% concentrations in water or in water and lower alcohol mixtures. Suitable solvents or solvent mixtures for preparing the dilute ionomer solution are those that solvate the acid-form ionomer concentrate solution and evaporate at an appropriate rate to form a defect-free separation layer in a timely manner. Residual or trace solvent remaining in the separation layer should not interfere with subsequent processing steps. For example, suitable solvents include but are not limited to lower alcohols such as ethanol, isopropanol, and n-propanol. Certain ketone, ether, amide, and ester solvents, and mixtures therefrom are also suitable as well as mixtures of the preceding solvents with fluorinated solvents such as Novec® HFE7200, and HFE7300. The separation layer thickness has a significant influence on the membrane productivity and cost of the separation process per unit area. The separation layer is preferably very thin having a thickness of 0.01-μm to 5.0-μm thick, more preferably 0.1-μm to 2-μm, and very preferably 0.1 to 1-μm.

The acid-form ionomer solution is cast onto a suitable porous-layer support porous-layer support using casting techniques that include but are not limited to ring casting, dip-coating, spin-coating, slot-die coating, and Mayer rod coating. The solvent(s) are then evaporated to form the “dry” separation layer. The porous-layer support mechanically strengthens the thin-film composite and allows for use of a thin separation layer. The porous-layer support may be in the form of a flat sheet, hollow fiber, or tube. A preferred porous-layer support material is expanded polytetrafluoroethylene, having a preferred mean pore size that is between 0.01 and 0.2-μm, preferably between 0.01 and 0.1 μm, and very preferably between 0.01 and 0.05-μm. Other suitable porous-layer support materials for less demanding filtration applications may include but are not limited to polyacrylonitrile, polysulfone, polyethersulfone, and polyvinylidine fluoride. The porous-layer support may also comprise an even stronger backing material such as woven or non-woven material including, but not limited to, polyester, polyamide, polypropylene, or polyethylene. Porous inorganic substrates such as porous silica or alumina are also suitable porous-layer support materials.

The thin-film composite of the invention may be subjected to a thermal treatment step “annealed” to enhance long-term separation performance and stability. The separation layer is annealed by heating the thin-film composite to near or above the glass transition temperature of the ionomer. The glass transition temperature will be dependent on the ionomer composition and the associated counter ion. Generally, annealing temperatures for a preferred acid-form ionomer are lower, relative to other counter ions, and between 50 and 250° C., and preferably between 150 and 200° C. The thin-film composite is preferably heated for 0.1 to 30 minutes, more preferably for 1 to 10 minutes. The appropriate annealing temperature and time should not degrade the other components of the thin-film composite.

A significant fraction of the thin-film composite separation performance, durability (annealed or otherwise), and resistance to swelling and dissolution is provided through electrostatic crosslinking of the separation layer ionomer precursor. Electrostatic crosslinking is accomplished by substitution of monovalent counter ions with multivalent counter ions in the ionomer separation layer. In a multivalent counter ion, the net charge is greater than or equal to 2 such that the ion can therefore coordinate with two or more covalently bound ionic groups in the separation layer ionomer. The separation layer precursor comprising an acid-form ionomer may be crosslinked by a multivalent counter ion (cation) that includes for example Ca²⁺, Mg²⁺, Ba²⁺, Al³⁺, Fe³⁺, Co²⁺, Ni²⁺, Cu²⁺, and Zn²⁺ or La³⁺. The multivalent cation may be incorporated by contacting the separation layer surface of the thin-film composite with a solution comprising a salt of the multivalent cation. Herein, contacting the separation layer can include the use of pressure to facilitate permeation of the multivalent cation solution through the thin-film composite to all accessible covalently-bound ionic groups. Preferred salt solutions of a multivalent cation include for example aqueous solutions of Ca(NO₃)₂, Fe(NO₃)₃, Ni(NO₃)₂, Mg(NO₃)₂, Al(NO₃)₃, and La(NO₃)₃. The cations permeate the acid-form ionomer and undergo equilibrium exchange with the acid-form ionomer protons to form the multivalent-cation salt of the ionomer. A preferred counter ion should not subsequently react or coordinate irreversibly with the solute or solvent during organic-solvent nanofiltration such that the thin-film composite membrane performance is degraded to an unacceptable level.

Very preferred multivalent counter ions originate or are formed from salt or salt-precursors that are reactive with the separation layer precursor. Reactive salts or salt precursors for an acid-form ionomer include for example aqueous calcium hydroxide (Ca(OH)₂), barium hydroxide (Ba(OH)₂), or a permeable polyamine such as N,N,N′,N′-tetramethylethylenediamine, or N,N,N′,N″,N″-pentamethyldiethylenetriamine, which are all examples of bases. Basic-salts or salt-precursors undergo acid-base reactions with the protons of a preferred acid-form ionomer to form a multivalent cation salt of the ionomer and also water in examples with hydroxide salts.

It was discovered that a sufficiently high level of counter-ion exchange and crosslinking could be achieved through contact of a reactive salt solution with the exposed separation layer surface of a preferred acid-form ionomer-precursor thin-film composite in 5 minutes or less. This was evident using aqueous Ca(OH)₂ and the resulting high rejection (i.e. ˜90% at 300-psig) of a Sudan Black B dye marker in DMF. Furthermore, counter-ion exchange of all accessible ionic groups may be facilitated by pressure filtration of the aqueous reactive salt through the thin-film composite. Maximum exchange using Ca(OH)₂ was inferred from an aqueous permeate that was basic to universal pH paper. Maximum counter ion exchange with salt solutions that undergo equilibrium with the acid-form ionomer may also be facilitated by pressure filtration.

### EXAMPLES

### Example 1. General Procedure for Thin-Film Composite Membrane Fabrication on an Expanded Polytetrafluoroethylene (ePTFE) Support

Al %-w/w solution of a copolymer of tetrafluoroethylene and 1,1,2,2-tetrafluoro-2-[(trifluoroethenyl)oxy]-ethanesulfonic acid was prepared by isopropanol dilution of commercially available Aquvion® D72-25BS or D79-25BS, both from Sigma-Aldrich (St. Louis, Mo.). The Aquivion® acid-form ionomers had an equivalent weight of approximately 720-g/mole and 790-g/mole respectively. The dilute solution was filtered prior to use through a glass microfiber filter having a mean porosity of approximately 1-μm. An approximately 127 mm×127 mm (5 in×5 in) piece of flat-sheet ePTFE having a 0.02-μm mean pore size was supported over a 70 mm (2.75 in) ID×76 mm (3 in) OD×19 mm (0.75 in) L stainless steel ring and secured with a stainless steel hose clamp. The inner ePTFE surface was then covered with the acid-form ionomer solution. The ePTFE turned translucent to transparent and after 10 to 30 seconds, the surface was slightly tilted and the excess acid-form ionomer solution was pipetted away from the surface. The “wet” film was dried in a level orientation on a heated plate at 40 to 45° C. in a ventilated enclosure that was gently purged with nitrogen. The thin-film composite was dried until the ePTFE was no longer translucent or transparent. A second layer was optionally added by repeating the coverage with the acid-form ionomer solution and subsequent drying. The resulting thin-film composite surface was shiny with subtle colored patterns that indicated that the separation layer formation was substantially at the surface of the ePTFE. Membranes that were selected to be annealed were subsequently heat treated in a forced-air convection oven while still supported in the stainless steel rings. The thin-film composite were annealed for 5 minutes at temperatures from 155 to 200° C., as noted in subsequent examples.

### Example 2. Calculation of Dry Separation Layer Film Thickness

An upper limit for the dry acid-form ionomer thickness in the separation layer of the thin-film composite was calculated from the “wet” acid-form ionomer film weight, the acid-form ionomer solution concentration ([% AFI]), the ePTFE surface area (38.3-cm²), and the acid-form ionomer density. Aquivion® has a reported density (p) of 2.06 -g/cm³. The separation layer thicknesses were calculated from the following equation and were less than 2-μm as shown in Table 1.

$$separation layer ( µm ) \leq \frac{{}_{ }^{″}{Wet}{}_{ }^{″} film ( g ) \times [ \% AFI ] \times 100}{ρ ( g / {cm}^{3} ) \times 38.3 ( {cm}^{2} )}$$

TABLE 1

| | | | “Wet” film | Cumulative SL dry |
|---|---|---|---|---|
| AFI EW | [% AFI] | Coating | (g) | thickness (μm) |
| 720 | 0.5 | 1^{st} | 0.391 | 0.25 |
| 720 | 0.5 | 2nd | 0.420 | 0.52 |
| 720 | 1 | 1^{st} | 0.451 | 0.57 |
| 720 | 1 | 2nd | 0.476 | 1.17 |
| 790 | 1 | 1^{st} | 0.322 | 0.41 |
| 790 | 1 | 2nd | 0.329 | 0.83 |

### Example 3. Counter-Ion Exchange and Electrostatic Crosslinking of Thin-Film Composite Membranes

Solutions of 0.1M NaOH, Ca(OH)₂ (saturated-0.02M), and 0.1M Al(NO₃)₃, were separately prepared by dissolving the corresponding salt (Sigma-Aldrich, St. Louis, Mo.) in water. Thin-film composite membranes prepared as described in example 1 were then electrostatically crosslinked by two different counter-ion exchange methods. In a surface-contact exchange method, the separation layer of a membrane while supported in its stainless-steel ring was covered (contacted) with a selected salt solution for a period of approximately 5 minutes. The salt solution was decanted and the separation layer surface was lightly rinsed with de-ionized water. Any remaining water drops were removed with an air purge. The membrane was then trimmed and removed from the stainless-steel support ring.

In the pressure-filtration exchange method, the membrane was first removed from the stainless-steel support ring. The membrane was mounted in a stainless-steel dead-ended pressure cell (HP4750, Sterlitech, Kent, Wash.) with the separation layer surface facing the reservoir. Approximately 10-mL of a selected aqueous salt solution was added to the pressure cell. The cell was pressurized with nitrogen at 300-psig to facilitate salt solution permeation of the membrane. In examples using aqueous Ca(OH)₂, the permeate pH was notably basic when tested with pH paper. The cell was de-pressurized and the membrane surface was rinsed and permeated with a small quantity (˜10-mL total) of the solvent to be tested. The membrane was then tested for organic-solvent nanofiltration as outlined in example 4.

### Example 4. Thin-Film Composite Membrane Flux Measurement

A selected thin-film composite membrane was mounted in a stainless-steel dead-ended pressure cell (HP4750, Sterlitech, Kent, Wash. 98032) with the separation layer surface facing the reservoir. Solutions of a 1-mM dye-marker solute were prepared by dissolving Sudan Black B (MW ˜457) in a selected polar aprotic solvent such as dimethylsulfoxide, (DMSO), N-Methyl-2-pyrrolidone (NMP), dimethylacetamide (DMAc), or dimethylformamide (DMF) Approximately 110-mL of a selected solution was added to the cell then the pressure cap was attached. The cell was magnetically stirred as it was pressurized with nitrogen at pressures between 100 and 600-psig. The active membrane surface area was 14.6-cm² and an initial 4 to 5 mL of permeate was collected before starting flux measurements. Permeate for flux and composition measurement was collected in a 10-mL graduated cylinder. 3.0-mL of permeate was collected at ambient temperature and the time was recorded. The cell was depressurized and a sample of the retentate and the latter permeate (each ˜0.5-mL) were set aside for measurement of membrane dye-marker rejection. Both permeate samples were added back to the cell; the cell was capped and set aside between subsequent measurements. A normalized permeate flux was calculated in units of LMH (liters/m²/hour).

### Example 5. Measurement of Dye-Marker Rejection in Thin-Film Composite Membranes

The dye-marker solute concentrations (Sudan Black B, MW ˜457-g/mole) in the retentate and permeate were measured by UV-VIS spectroscopy. Samples of retentate and permeate were separately and quantitatively diluted with fresh solvent in the quartz cuvette such that the maximum absorbance (between 600 and 650-nm) were less than 2 and preferably closer to 1. The percentage of dye marker rejected by the membrane was calculated from the following equation wherein R and P are the masses of retentate and permeate sample, respectively; P_{dil.} and R_{dil.} are the diluted masses of permeate and retentate, respectively; and A_{P} and A_{R} are the absorbance of diluted permeate and diluted retentate, respectively.

$$Rejection ( \% ) = ( 1 - \frac{R}{P} \times \frac{{P}_{dil .}}{{R}_{dil .}} \times \frac{{A}_{P}}{{A}_{R}} ) \times 100 \%$$

### Example 6. Counter Ion (Electrostatic Crosslinking) Effect on Initial Thin-Film Composite Membrane Performance

Four thin-film composite membranes were prepared using the 720 equivalent weight acid-form ionomer without annealing as described in example 1. Three of the membranes were then counter ion exchanged by the surface contact method as described in example 3 with either a monovalent Na⁺ counter ion, divalent Ca²⁺ counter ion, or an Al³⁺ trivalent counter ion. Membranes were then tested for initial DMF flux (300-psig) as described in example 4 and initial Sudan Black B dye rejection (separation) as described in example 5. The results are shown in Table 2. Membranes with multivalent counter ions showed reasonable to good DMF flux and dye rejection above 88% and as high as 98.7%. Comparative membranes 6A and 6B, having monovalent counter ions, had no or minimal dye rejection and extremely high DMF flux, likely as a result of excessive swelling and partial dissolution.

TABLE 2

| | | Initial | Dye |
|---|---|---|---|
| | | DMF Flux | Rejection |
| Membrane | Cation | (LMH) | (%) |
| Comparative 6A | H⁺ | 110 | 0 |
| Comparative 6B | Na⁺ | 230 | 0.9 |
| 6-3 | Ca²⁺ | 19 | 88.4 |
| 6-4 | Al³⁺ | 4.6 | 98.7 |

### Example 7. Annealing Effect on Initial Thin-Film Composite Membrane Performance

Several thin-film composite membranes were prepared using the 790 equivalent weight acid-form ionomer as described in example 1. Membranes were then annealed for 5 minutes at a selected temperature between 155 to 200° C. as shown in Table 3. Most of the membranes were exchanged with either a monovalent Na⁺ counter ion, divalent Ca²⁺ counter ion, or an Al³⁺ trivalent counter ion as described in example 3. Membranes were then tested for initial DMF flux (300-psig) as described in example 4 and Sudan Black B dye separation as described in example 5. All membranes had higher initial dye rejection resulting from the annealing step. Membranes having a multivalent counter ion had the highest initial dye rejections above 93%.

TABLE 3

| | | | Initial | Dye |
|---|---|---|---|---|
| | | | DMF Flux | Rejection |
| Membrane | Annealing | Cation | (LMH) | (%) |
| Comparative 7A | 155° C., 5 min | H⁺ | 64 | 39.2 |
| Comparative 7B | 155° C., 5 min | Na⁺ | 64 | 54.8 |
| Comparative 7C | 200° C., 5 min | Na⁺ | 20 | 89.1 |
| 7-1 | 155° C., 5 min | Ca²⁺ | 11.5 | 93.6 |
| 7-2 | 175° C., 5 min | Ca²⁺ | 8.3 | 95.6 |
| 7-3 | 200° C., 5 min | Ca²⁺ | 5.0 | 96.1 |
| 7-4 | 155° C., 5 min | Al³⁺ | 1.4 | 98.1 |

### Example 8. Effect of Counter-Ion and Annealing on Longer-Term Membrane Performance

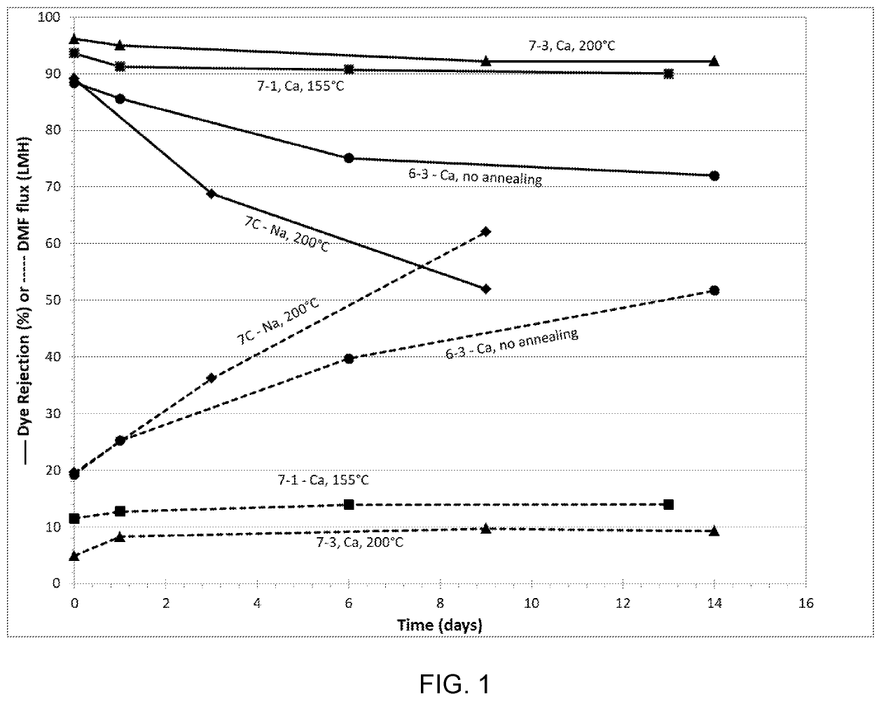

Selected thin-film composite membranes from examples 6 and 7 having sodium or calcium counter-ions were stored in contact with the DMF solvent in the pressure cell and periodically tested for DMF flux (300-psig) and Sudan Black B dye rejection over a two week period. The results are plotted in FIG. 1 and showed that for comparative membrane 7C, having a monovalent sodium counter ion and annealed at 200° C., the dye rejection decreased substantially from an initial 89% to near 50% while the permeance had increased by approximately 200%. Thin-film composite membranes with divalent calcium counter-ions were more stable and the annealed thin-film composite membranes with calcium counter-ions showed notably stable long-term flux and dye rejection.

### Example 9. Reversible Pressure Effect on Membrane Separation Efficiency

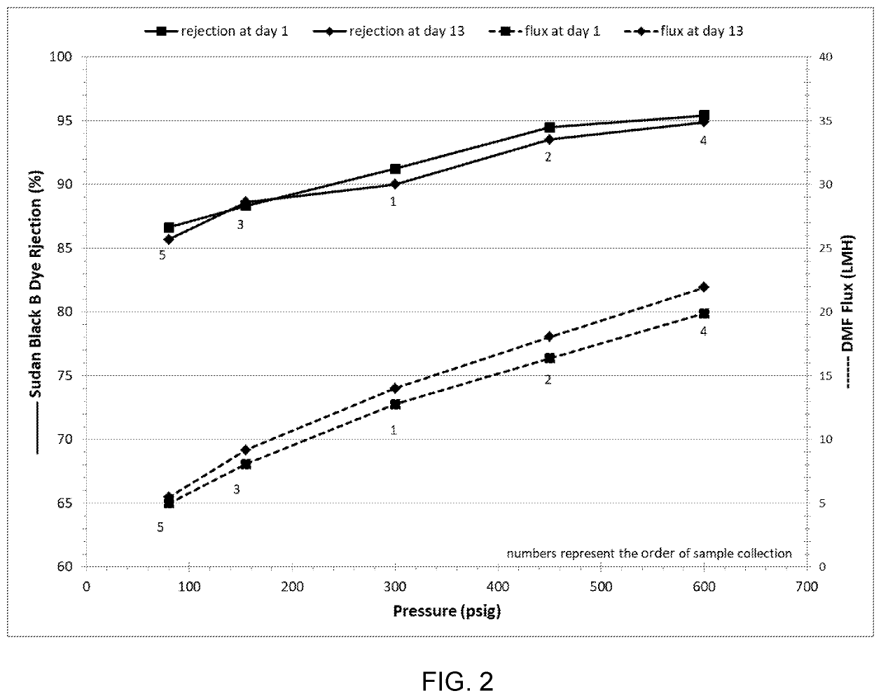

Membrane 7-1 that had been annealed at 155° C. and electrostatically crosslinked with a calcium counter ion by the surface contact method was tested at varied pressures for Sudan Black B dye rejection and DMF flux, initially at day 1 and at day 13. The results are plotted in FIG. 2 and showed similar dye rejections and flux profiles over time with membrane flux having slightly increased at higher pressures at day 13. Higher DMF fluxes with higher pressures were expected. However, the increased dye rejection at higher pressures was unexpected. The dye rejection appeared to be readily reversible given that the DMF flux and rejection profiles were not affected by a sample collection protocol that alternated between high and low pressures.

### Example 10. Effect of Counter Ion Exchange Method and Amine Contact on Membrane Performance

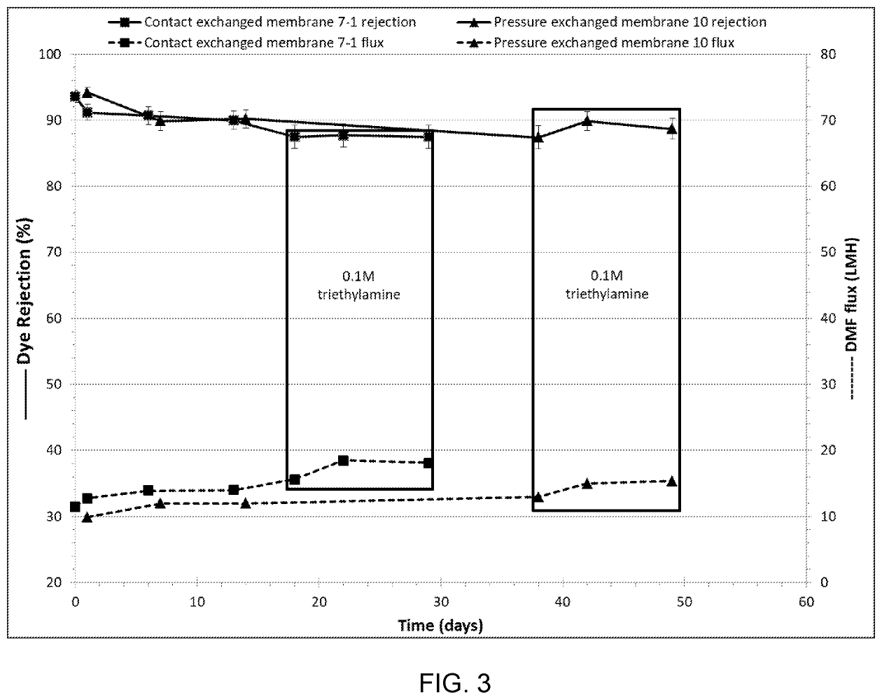

An annealed (155° C.) membrane (10) was prepared according to example 1 and was electrostatically crosslinked with aqueous Ca(OH)₂ using the pressure counter-ion exchange method as outlined in example 3. The membrane was periodically tested over approximately 50 days at 300-psig for DMF flux (example 4) and Sudan Black B dye rejection (example 5). The membrane was also stored in contact with the DMF solvent in the pressure cell when not in use. At 38 days, approximately 0.1M trimethylamine (TEA) was added to the solvent reservoirs of membrane 10 and at 17 days for contact-exchanged membrane 7-1, respectively. FIG. 3 showed that dye rejections remained largely unchanged within estimated error limits at approximately 87 to 90%. DMF fluxes may have slightly increased with TEA addition but the membranes appeared stable overall.

### Example 11. Effect of Counter Ion Exchange Method and Pressure on Membrane Performance

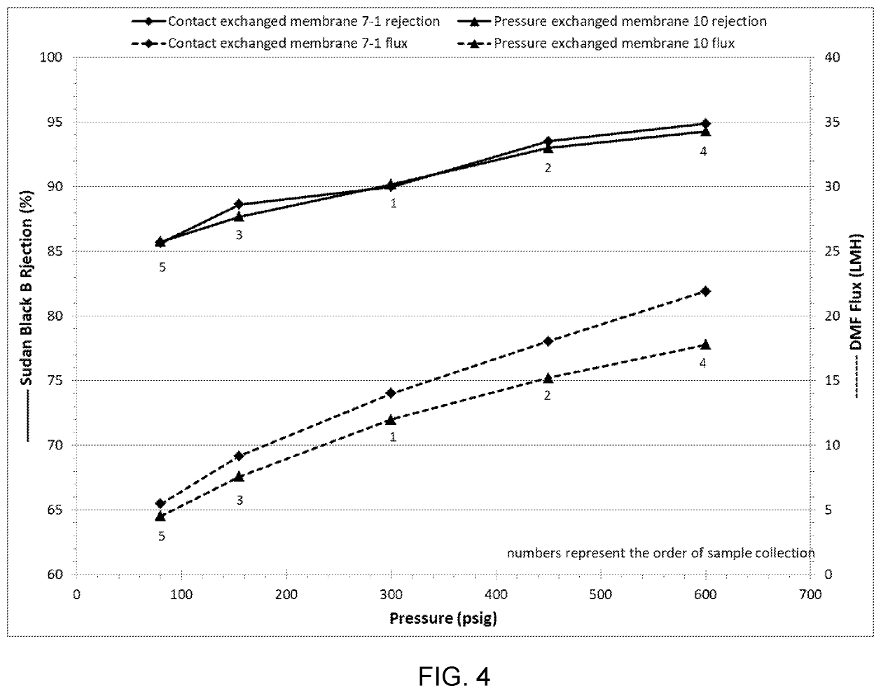

Membrane 10, that had been crosslinked with aqueous Ca(OH)₂ using the pressure-filtration counter-ion exchange method, was also pressure tested at 14 days. FIG. 4 showed dye rejection and DMF flux profiles that varied with pressure and was reversible. The profiles were similar to contact-exchanged membrane 7-1 (also shown), which had a moderately higher DMF flux.

### Example 12. Effect of Pressure-Filtration Exchange on Membrane Performance with and without Annealing

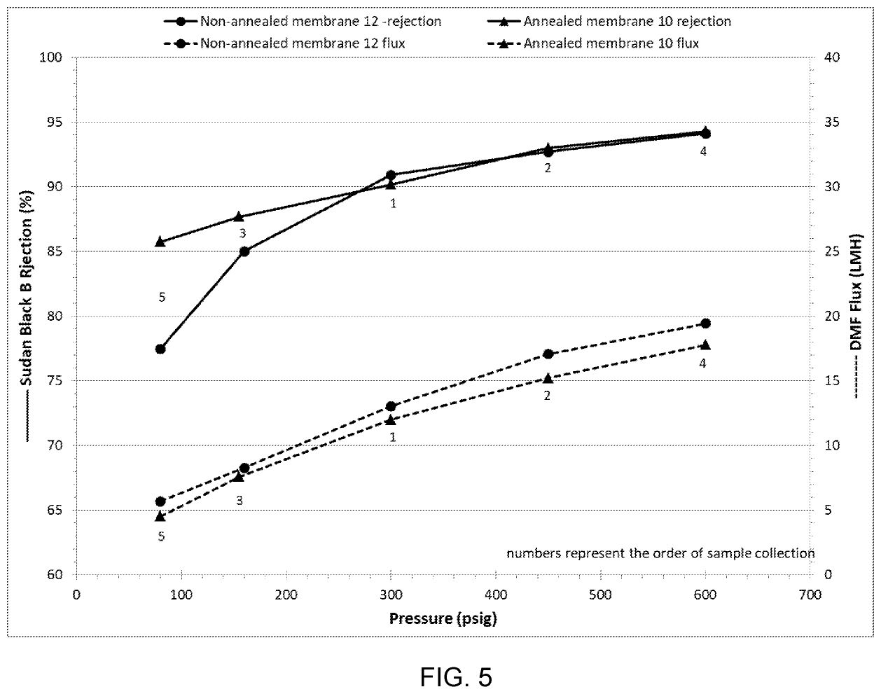

Non-annealed membrane (12) was prepared according to example 1 and was electrostatically crosslinked with aqueous Ca(OH)₂ using the pressure-filtration exchange method as outlined in example 3. Membrane 12 was periodically tested at 300-psig over two weeks for DMF flux (example 4) and Sudan Black B dye rejection (example 5). At two weeks, membrane 12 was tested at varied pressures and FIG. 5 showed a flux profile that was similar to annealed membrane 10. The dye rejection profile for membrane 12 appeared to be more sensitive to pressure.

### Example 13. Membranes Having Aluminum Counter Ions

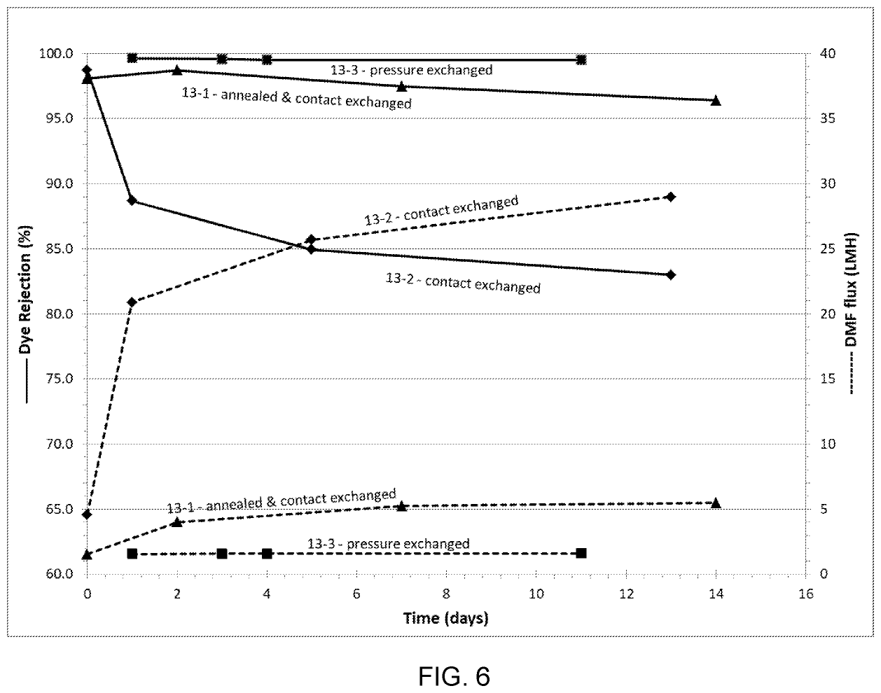

Annealed membrane (13-1) and two non-annealed membranes (13-2 and 13-3) were prepared according to example 1. Membranes were treated as outlined in example 3 using 0.1M aqueous Al(NO₃)₃; 13-1 and 13-2 using the surface-contact exchange method and membrane 13-3 using the pressure-filtration exchange method. Membranes were stored in contact with the DMF in the pressure cell and periodically tested at 300-psig over two weeks for DMF flux (example 4) and Sudan Black B dye rejection (example 5). FIG. 6 showed that the fabrication method had a significant influence on performance for membrane incorporating and aluminum counter-ion. Membranes 13-1 and 13-3 that were either annealed or pressure-filtration exchanged had more stable dye rejections, from 95 to above 99%, and more stable DMF fluxes than contact exchanged membrane 13-2 over at least 2 weeks.

### Example 14. Effect of Thickness on Membrane Performance

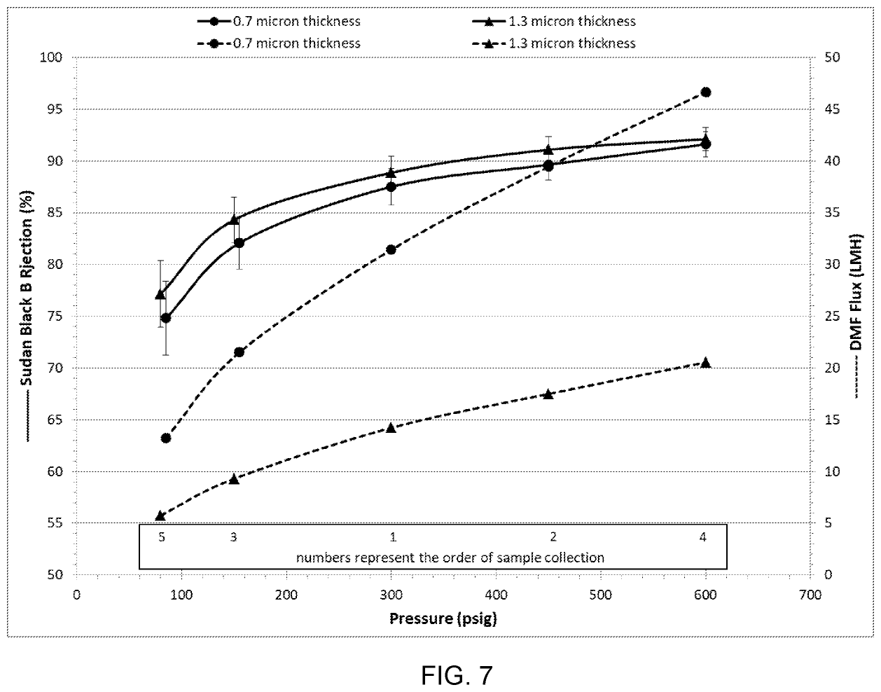

Two membranes were prepared using the 720 equivalent weight acid-form ionomer according to example 1. One membrane separation layer (14-1) was prepared at approximately half thickness (0.7-μm) from a single coating of the acid-form ionomer solution. Both membranes were tested at varied pressures. FIG. 7 showed that the flux profile for the thinner membrane 14-1 was at least two times higher at a given pressure, as anticipated, while the dye rejection profile appeared slightly lower but may be similar within estimated errors.

### Example 15. Membrane Flux with Various Solvents

Membrane 14-1 was tested for initial flux using various solvents as outlined in the following Table 4. For a selected solvent, the membrane, while remaining in the pressure cell, was first rinsed with the solvent and then a quantity of the solvent was added to the cell reservoir above the membrane

TABLE 4

| Solvent | Pressure (psig) | Flux (LMH) |
|---|---|---|
| 1-butanol | 450 | 0.55 |
| Ethyl acetate | 450 | 3.3 |
| Ethanol | 450 | 3.5 |
| Methanol | 450 | 27.3 |
| NMP | 450 | 8.8 |
| DMSO | 450 | 17.1 |
| DMSO | 600 | 17.7 |
| DMSO (day 3) | 750 | 28.3 |

What is claimed is:

1. A thin-film composite membrane comprising:
a) a porous-layer support;
b) an ionomer layer comprising covalently-bound ionic groups, said ionomer layer coupled to said porous-layer support;
c) a multivalent counter ion electrostatically crosslinked to at least some of the covalently-bound ionic groups within the ionomer layer;
wherein the thin-film composite membrane has a separation efficiency that is reversibly pressure tunable, for the separation of at least one organic solvent from a solution comprising at least one solute.

2. The thin-film composite membrane of claim 1 wherein the porous-layer support material comprises expanded polytetrafluoroethylene.

3. The thin-film composite membrane of claim 1 wherein the ionomer layer comprises a fluoropolymer.

4. The thin-film composite membrane of claim 1 wherein the ionomer layer comprises a perfluoropolymer.

5. The thin-film composite membrane of claim 1 wherein the ionomer layer comprises a copolymer of 1,1,2,2-tetrafluoro-2-[(trifluoroethenyl)oxy]ethanesulfonate and tetrafluoroethylene.

6. The thin-film composite membrane of claim 1 wherein the thin-film composite membrane is subjected to a thermal treatment step.

7. The thin-film composite membrane of claim 1 wherein the multivalent counter ion is selected from a group consisting of Ca²⁺ and Al³⁺.

8. The thin-film composite membrane of claim 1, wherein the multivalent counter ion precursor salt comprises calcium hydroxide.

9. The thin-film composite membrane of claim 1, wherein the multivalent counter ion precursor salt comprises aluminum nitrate.

10. The thin-film composite membrane of claim 1 wherein the ionomer layer thickness is less than 2 microns.

11. The thin-film composite membrane of claim 1 wherein the ionomer layer is configured substantially on a surface of the porous-layer support.

12. A method of separation of a solution comprising at least one organic solvent and at least one solute comprising:
a) providing the thin-film composite membrane as described in claim 1;
b) exposing the thin-film composite membrane feed side to a solution; and
c) providing a pressure driving force and producing a solution composition on the permeate side having a lower solute concentration than the feed-side composition.

13. The method of claim 12 wherein the organic solvent comprises a polar aprotic solvent.

14. The method of claim 12, wherein the solute comprises an amine.

15. The method of claim 12 wherein the porous-layer support material comprises expanded polytetrafluoroethylene.

16. The method of claim 12 wherein the ionomer layer comprises a fluoropolymer.

17. The method of claim 12 wherein the ionomer layer comprises a perfluoropolymer.

18. The method of claim 12 wherein the ionomer comprises a copolymer of 1,1,2,2-tetrafluoro-2-[(trifluoroethenyl)oxy]ethanesulfonate and tetrafluoroethylene.

19. The method of claim 12, wherein the multivalent counter-ion is selected from a group consisting of: Ca²⁺ and Al³⁺.

20. A method of separation of a solution comprising at least one organic solvent and at least one solute comprising exposing a thin-film composite membrane feed side to a solution at a pressure driving force and producing a solution composition on the permeate side having a lower solute concentration than the feed-side composition.
wherein the thin-film composite membrane comprises:
a porous-layer support; an ionomer layer comprising covalently-bound ionic groups, said ionomer layer coupled to said porous-layer support; and
a multivalent counter ion electrostatically crosslinked to at least some of the covalently-bound ionic groups within the ionomer layer;
wherein the thin-film composite membrane has a separation efficiency that is reversibly pressure tunable, for the separation of at least one organic solvent from a solution comprising at least one solute.
